(19) United States
(12) Patent Application Publication
(10) Pub. No.: US 2010/0235685 A1
(43) Pub. Date: Sep. 16, 2010

(54) DEVICE AND METHOD FOR GENERATING TEST CASE AND COMPUTER-READABLE RECORDING MEDIUM

(75) Inventor: Hiromasa Shin, Yokohama-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/719,945

(22) Filed: Mar. 9, 2010

(30) Foreign Application Priority Data
Mar. 10, 2009 (JP) 2009-056514

(51) Int. Cl. G06F 11/26

(52) U.S. Cl. 714/37; 714/E11.159

(57) ABSTRACT

When the system state transition diagram creator sequentially generates transition events based on a system operation specification to create a system state transition diagram, the creator restricts the transition event to be next executed by a scenario state transition diagram restricting the order of execution of the transition events, and test case generator generates a test case based on thus created system state transition diagram.

### CROSS REFERENCE TO RELATED APPLICATIONS

This application is based upon and claims the benefit of priority from the prior Japanese Patent Application No. 2009-56514, filed on Mar. 10, 2009, the entire contents of which are incorporated herein by reference.

### BACKGROUND OF THE INVENTION

1. Field of the Invention

The present invention relates to a device and a method for generating a test case, and a computer-readable recording medium for storing a computer program for generating the test case.

2. Related Art

As a conventional method, a system state transition diagram is created by searching the states described in a system operation specification and a test case is created to cover every transition which could be executed (generated) in the system state transition diagram. The test case created in this way has an advantage that every transition which can be generated among the states can be listed and covered.

However, the above method has a problem that the scale of the system state transition diagram and that of the test case are exponentially increased when the system operation specification is complicated. Further, there is a problem that overlapped transitions are numerously included in the test case created for a large system state transition diagram under a specific test restriction.

The method for generating a test case can be regarded as a method for exhaustively listing transitions which could be generated under a specific test restriction. Various test restrictions can be supposed, and it is well known to restrict the kinds of transition events, for example. However, in this method, the operability of the test is impaired since complicated operation reflecting the actual system cannot be reproduced in the system state transition diagram.

### SUMMARY OF THE INVENTION

According to an aspect of the present invention, there is provided with a test case generating device including a computer readable storage medium containing a set of instructions that causes a computer processor to perform generating a test case for a target system, comprising:

a first storage configured to store a system operation specification describing: a plurality of first variables representing a first state by a combination of values thereof; a plurality of transition events; a plurality of pre-conditions each to be satisfied by the first variables in order to execute each of the transition events; and a formula for updating values of the first variables when each of the transition events is executed;

a second storage configured to store a scenario state transition diagram describing transitions among a plurality of second states in accordance with execution of the transition events;

a first creator configured to create a system state transition diagram describing transitions among first states in accordance with the execution of the transition events based on the system operation specification and the scenario state transition diagram;

a test case generator configured to generate a test case which is a series of transition events covering all transitions in the system state transition diagram by sequentially tracing each transition in the system state transition diagram; and

a test case output unit configured to output the test case,

wherein

the first creator

has a first list and a second list for temporarily storing data;

generates an initial first state by determining initial values of the first variables;

specifies an initial second state of the second states in the scenario state transition diagram;

detects a common transition event which can be executed both at the initial first state and the initial second state from among the transition events the pre-conditions and the scenario state transition diagram;

transits the initial first state and the initial second state by the common transition event to obtain a transited first state and a transited second state, and stores, in the first list, a set of items of the initial first state, the common transition event and the transited first state;

stores a composite state which is a pair of the transited first state and the transited second state, in the second list;

(A) selects the composite state which is not previously selected, in the second list;

(B) detects a common transition event which can be executed both at the first state and the second state included in a selected composite state from among the transition events, transits the first state and the second state by the common transition event to obtain a transited first state and a transited second state, and stores a set of items of the first state in the selected composite state, the common transition event and the transited first state, in the first list;

(C) stores a composite state which is a pair of the transited first state and the transited second state obtained in the step (B), in the second list when the composite state does not exist in the second list; and

repeats the steps (A) to (C) until all of composite states existing in the second list are selected at the step (A) and then obtains all of sets existing in the first list as representing the system state transition diagram.

According to an aspect of the present invention, there is provided with a computer-implemented method of generating a test case for a target system, comprising:

reading out a system operation specification from a first storage, the system operation specification describing: a plurality of first variables representing a first state by a combination of values thereof; a plurality of transition events; a plurality of pre-conditions each to be satisfied by the first variables in order to execute each of the transition events; and a formula for updating values of the first variables when each of the transition events is executed;

reading out from a second storage, a scenario state transition diagram describing transitions among a plurality of second states in accordance with execution of the transition events;

creating a system state transition diagram describing transitions among first states in accordance with the execution of the transition events based on the system operation specification and the scenario state transition diagram;

generating a test case which is a series of transition events covering all transitions in the system state transition diagram by sequentially tracing each transition in the system state transition diagram; and

outputting the test case,

wherein

the creating the system state transition diagram including:

generating an initial first state by determining initial values of the first variables;

specifying an initial second state of the second states in the scenario state transition diagram;

detecting a common transition event which can be executed both at the initial first state and the initial second state from among the transition events the pre-conditions and the scenario state transition diagram;

transiting the initial first state and the initial second state by the common transition event to obtain a transited first state and a transited second state, and storing, in a first list, a set of items of the initial first state, the common transition event and the transited first state;

storing a composite state which is a pair of the transited first state and the transited second state, in a second list;

(A) selecting the composite state which is not previously selected, in the second list;

(B) detecting a common transition event which can be executed both at the first state and the second state included in a selected composite state from among the transition events, transiting the first state and the second state by the common transition event to obtain a transited first state and a transited second state, and storing a set of items of the first state in the selected composite state, the common transition event and the transited first state, in the first list;

(C) storing a composite state which is a pair of the transited first state and the transited second state obtained in the step (B), in the second list when the composite state does not exist in the second list; and

repeating the steps (A) to (C) until all of composite states existing in the second list are selected at the step (A) and then obtaining all of sets existing in the first list as representing the system state transition diagram.

According to an aspect of the present invention, there is provided with a computer-readable recording medium storing a computer program for causing a computer to execute instructions to perform steps of:

reading out a system operation specification from a first storage, the system operation specification describing: a plurality of first variables representing a first state by a combination of values thereof; a plurality of transition events; a plurality of pre-conditions each to be satisfied by the first variables in order to execute each of the transition events; and a formula for updating values of the first variables when each of the transition events is executed;

reading out from a second storage, a scenario state transition diagram describing transitions among a plurality of second states in accordance with execution of the transition events;

creating a system state transition diagram describing transitions among first states in accordance with the execution of the transition events based on the system operation specification and the scenario state transition diagram;

generating a test case which is a series of transition events covering all transitions in the system state transition diagram by sequentially tracing each transition in the system state transition diagram; and

outputting the test case,

wherein

the creating the system state transition diagram including:

generating an initial first state by determining initial values of the first variables;

specifying an initial second state of the second states in the scenario state transition diagram;

detecting a common transition event which can be executed both at the initial first state and the initial second state from among the transition events the pre-conditions and the scenario state transition diagram;

transiting the initial first state and the initial second state by the common transition event to obtain a transited first state and a transited second state, and storing, in a first list, a set of items of the initial first state, the common transition event and the transited first state;

storing a composite state which is a pair of the transited first state and the transited second state, in a second list;

(A) selecting the composite state which is not previously selected, in the second list;

(B) detecting a common transition event which can be executed both at the first state and the second state included in a selected composite state from among the transition events, transiting the first state and the second state by the common transition event to obtain a transited first state and a transited second state, and storing a set of items of the first state in the selected composite state, the common transition event and the transited first state, in the first list;

(C) storing a composite state which is a pair of the transited first state and the transited second state obtained in the step (B), in the second list when the composite state does not exist in the second list; and

repeating the steps (A) to (C) until all of composite states existing in the second list are selected at the step (A) and then obtaining all of sets existing in the first list as representing the system state transition diagram.

### BRIEF DESCRIPTION OF THE DRAWINGS

FIG. 1 is a block diagram showing a test case generating device according to an embodiment of the present invention.

FIG. 2 is a flow chart showing a flow of the operation performed by the system state transition diagram creator in the device of FIG. 1.

FIG. 3 is a diagram showing an example of a system operation specification for a vending machine.

FIG. 4 is a diagram showing a system-state transition table (conventional example).

FIG. 5 is a diagram showing a system state transition diagram (conventional example).

FIG. 6 is a diagram showing a scenario-state transition table (example 1).

FIG. 7 is a diagram showing a scenario state transition diagram (example 1).

FIG. 8 is a diagram showing a scenario-state transition table (example 2).

FIG. 9 is a diagram showing a scenario state transition diagram (example 2).

FIG. 10 is a diagram showing a state transition table as to a composite state.

FIG. 11 is a diagram showing a table obtained by projecting the table of FIG. 10 to a system state.

FIG. 12 is a diagram showing a system state transition diagram (example 1).

FIG. 13 is a diagram showing a system state transition diagram (example 2).

FIG. 14 is a diagram showing example 1 of a test case (transition path).

FIG. 15 is a diagram showing example 2 of the test case (transition path).

FIG. 16 is a diagram showing a (conventional) example of the test case (transition path).

### DETAILED DESCRIPTION OF THE INVENTION

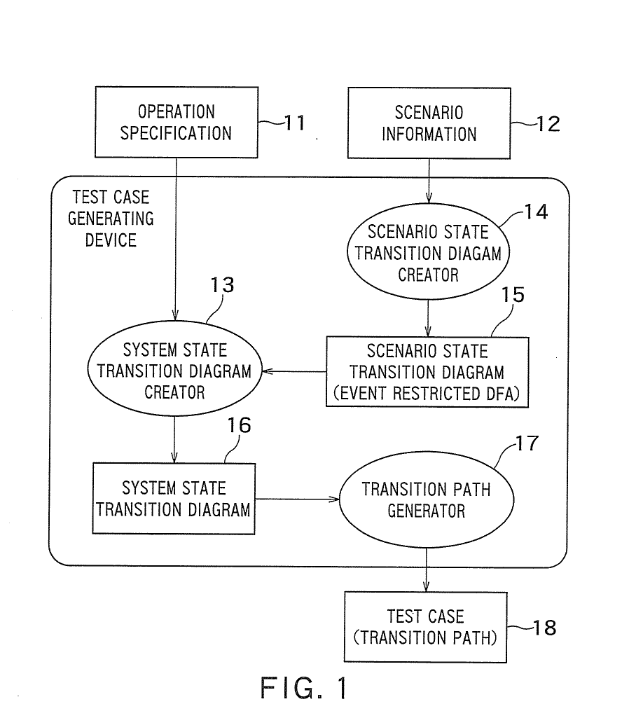

FIG. 1 is a block diagram showing a test case generating device according to an embodiment of the present invention.

Hereinafter, the summary of this device will be explained first, and after that, more detailed explanation thereof will be made by using a concrete example.

A system operation specification 11 (hereinafter simply referred to as an operation specification according to circumstances) describes: a plurality of first variables whose values represent a state (first state) of a target system; a plurality of transition events; a pre-condition which should be satisfied by the plurality of first variables in order to permit execution (or generation) of each of the plurality of transition events; and an formula for updating the values of the first variable when each of the plurality of transition events is executed. The operation specification 11 is read from a storage device connected to the test case generating device, and is temporarily stored in an internal buffer of the test case generating device. In the present invention, a first storage for storing the operation specification may be the storage device or may be the internal buffer.

A scenario information 12 includes a transition event order description (scenario description) describing a scenario of the order in which the plurality of transition events are executed. Further, the scenario information 12 includes a correspondence table (correspondence information) showing the correspondence among a second state (pre-state), a transition event, and a transited second state (post-state) when the transition event is executed at the second state. The second state is expressed by the value of a second variable. For example, when there is a correspondence among a state q0, a certain transition event and a state q1 in the correspondence table, it shows that the state q0 transits to the state q1 when the certain transition event is executed at the state q0. Each of the states q0 and q1 is an example of the value of the second variable. The scenario information 12 is read from a storage device connected to the test case generating device, and is input into the test case generating device.

A scenario state transition diagram creator (a second creator) 14 executes (generates) the transition events in accordance with the restrictions of the transition event order (i.e. scenario) based on the correspondence table in the scenario information 12 to create a scenario state transition diagram 15 describing transitions among a plurality of second states by the occurrence of the transition events (see Document 1: ISBN-4781910262, J. Hoperoft et al., “Introduction to Automata Theory, Languages, and Computation,” SAIENSU-SHA Co., Ltd. (2003).) The scenario state transition diagram 15 can be called an event restricted DFA (Deterministic Finite Automaton). In the present embodiment, the scenario information 12 is input to create the scenario state transition diagram 15. However, it is also possible to store the scenario state transition diagram 15 previously created by a user etc. in a storage device and read the scenario state transition diagram from the storage device. The read diagram 15 is stored in an internal buffer of the test case generating device. In this case, the scenario state transition diagram creator 14 can be omitted. In the present invention, a second storage for storing the scenario state transition diagram may be the storage device or may be the internal buffer.

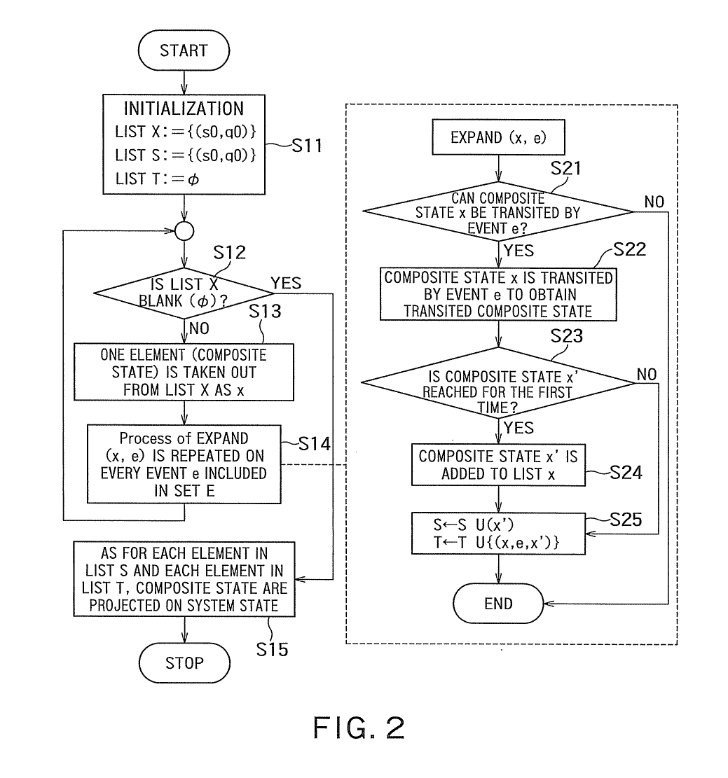

A system state transition diagram creator (first creator) 13 sequentially executes (generates) transition events which can be executed in the operation specification 11 in the order starting from the initial state (initial first state) of the target system to create a system state transition diagram 16 describing transitions among the first states by occurrence of a plurality of transition events. At this time, the events to be executed are restricted by the scenario state transition diagram 15. In other words, when creating the system state transition diagram, transition events to be sequentially executed is restricted to only transition events which can be transited also in the scenario state transition diagram among the transition events which can be executed in the system operation specification. The details of the system state transition diagram creator 13 will be explained later by using the flow chart of FIG. 2.

A transition path generator (test case generator) 17 generates a transition path (or a test case), which is a transition event series covering every transition in the system state transition diagram 16, by tracing each transition in the system state transition diagram 16. The transition path generator 17 includes an output unit for outputting the generated transition path (test case) to the outside.

The test case generating device includes a computer readable storage medium containing a set of instructions that causes a computer processor to perform a data processing process of generating a test case for a target system. Specifically, each of the system state transition diagram creator 13, the scenario state transition diagram creator 14, and the transition path generator 17 can be formed of hardware, software (program), or their combination. When each of the elements 13 to 15 is formed of a program, its operation can be performed by carrying out the program stored in a storage medium such as a hard disk device, memory device, and CD-ROM to be read by an arithmetic device such as a CPU.

Hereinafter, the device of FIG. 1 will be explained in detail based on an example of the operation specification for a vending machine.

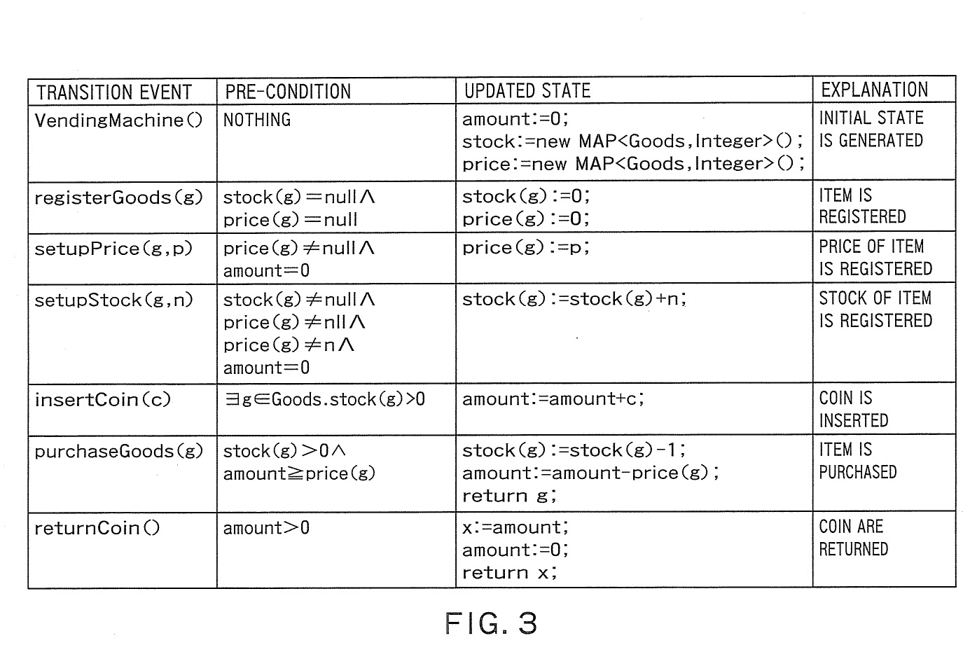

The table of FIG. 3 shows an example of a simplified system operation specification for a vending machine. This operation specification describes the change in the internal state (first state) of the vending machine in accordance with the operation of the vending machine. This operation specification includes: (1) state variables (first variables) of the system; (2) transition events for changing the state variables; (3) a pre-condition for judging whether each of the transition events can be executed; and (4) a formula for updating the state when each of the transition events is executed. The internal state (first state) of the system is expressed by the values of the state variables (first variables).

In the example of FIG. 3, the state variables (first variables) of the system are: “price” expressing the price of an item; “stock” expressing the stock of items; and “amount” expressing the amount of inserted coins.

The events (transition events) which transit (change) the state of the vending machine are: “VendingMachine( )” for initializing the state; “registerGoods(g)” for registering an item g; “setupPrice(g, p)” for setting a price p of the item g; “setupStock(g, n)” for setting a stock n of the item g; “insertCoin(c)” for inserting a coin whose amount is c; “purchaseGoods(g)” for purchasing the item g; and “returnCoin( )” for returning a coin.

Each transition event is associated with a pre-condition representing occurrence condition of the event (a restriction which should be established before the event is executed) and an updated state after change in the state variables when the event is executed. Each transition event can be executed when its corresponding pre-condition is satisfied. When each transition event is executed, the state is updated corresponding thereto.

For example, the pre-condition of the event “purchaseGoods(g)” for purchasing the item g is that “stock(g)” expressing the stock of the item g is a positive number (stock(g)>0) and “amount” expressing the amount of inserted coins is equal to or greater than “price(g)” expressing the price of the item g (amount≧price(g)). The event “purchaseGoods(g)” can be executed when this pre-condition is satisfied. When the event “purchaseGoods(g)” is executed, the state is updated by subtracting one item from “stock(g)” expressing the stock of the item g (stock(g):=stock(g)−1), subtracting “price(g)” expressing the price of the item g from the amount of the inserted coins (amount:=amount−price(g)), and delivering the item (return g).

An operation specification similar to the table of FIG. 3 can be expressed by using the Java programming language, and its concrete example will be shown in the end of the specification. The operation specification should include the description concerning the abovementioned items (1) to (4) regardless of whether it is based on the table of FIG. 3 or the Java program notation.

The operation specification shown by the table of FIG. 3 makes it possible to create a system state transition diagram expressing the transition relationship between a system state and a transition event. The present embodiment is greatly characterized in that the system state transition diagram 16 is created considering the restrictions of the scenario state transition diagram (event restricted DFA) 15. However, in order to provide an easy understanding, a case where the system state transition diagram is created by using only the operation specification will be firstly shown.

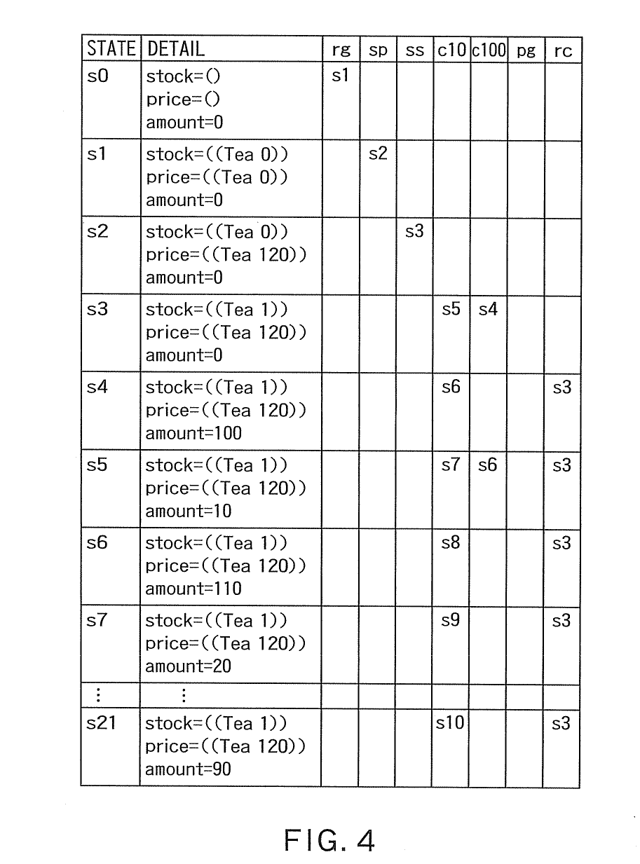

The table of FIG. 4 shows an example of a system state transition diagram created based on the operation specification of the vending machine (here, it should be noted that restrictions of the scenario state transition diagram are not considered). In the table of FIG. 4, the following abbreviations are used to describe the transition events. For example, the abbreviation “rg” means the transition event “registerGoods” for registering the item “Tea.”

| Transition events | Abbreviations | Explanations |
|---|---|---|
| (registerGoods Tea) | rg | Item is registered |
| (setupPrice Tea 120) | sp | Price is registered |
| (setupStock Tea 1) | ss | Item is added |
| (insertCoin 10) | c10 | 10 yen coin is inserted |
| (insertCoin 100) | c100 | 100 yen coin is |
| | | inserted |
| (purchaseGoods | pg | Item is purchased |
| Tea) | | |
| (returnCoin) | rc | Coins are returned |

The steps for creating the table of FIG. 4 will be explained in the following.

Step 1: The initial state of the system is set to a state after the initialization process “VendingMachine( )” (labeled s0), and thus a state s0 is registered in the first row in the table of FIG. 4. The state s0 is a state in which no item is registered (stock=( )), the price of the item is not registered (price=( ), and the amount of inserted coins is 0 (amount=0).

Step 2: transition events which can be executed at the state s0 are searched by examining the pre-condition of each transition event. The table of FIG. 3 shows that only the event “rg” for registering the item can be executed at the state s0.

Step 3: The registration of the item g at the state s0 generates a new state (labeled s1), in which the values of the price and stock of the item g are both 0 (stock=((Tea 0)), price=((Tea 0))) and the amount of inserted coins is 0 (amount=0). Here, “Tea” is registered as the item g.

Step 4: the new state s1 is registered in the second row in the table of FIG. 4, and events which can be executed are similarly searched. The table of FIG. 3 shows that only the event “sp” for registering the price of the item can be executed.

Step 5: Transition events which can be executed in the present state are continuously executed in a similar way. When a new state is generated, the new state is registered in the table of FIG. 4, and similar steps are repeated from the new state. The process is continued until no more new state is generated. In this way, it is possible to obtain the table of FIG. 4 showing the states and the transitions therebetween.

Note that the state transition diagram (state transition table) in the table of FIG. 4 is created under the restrictions that the amount of inserted coins is within 150 yen and the number of stocked items is 1 as one example. This is because an infinite number of states (of the vending machine) can be theoretically generated if no restriction is added to the amount of inserted coins and the number of stocked items. Concretely, only a new state generated to satisfy these restrictions is added to the table.

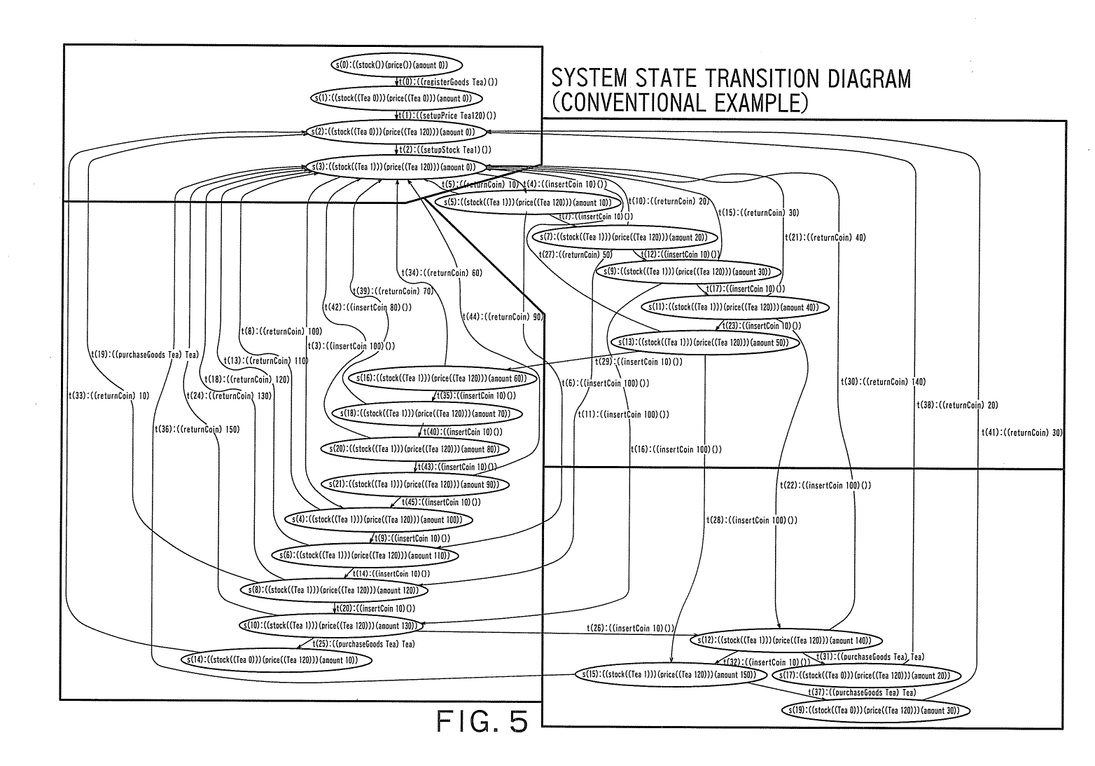

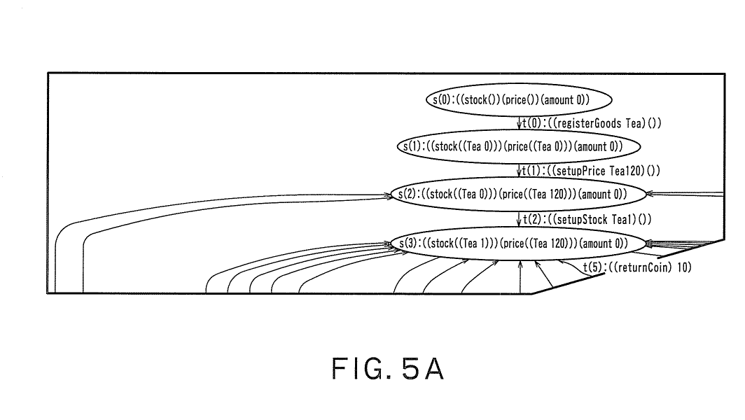

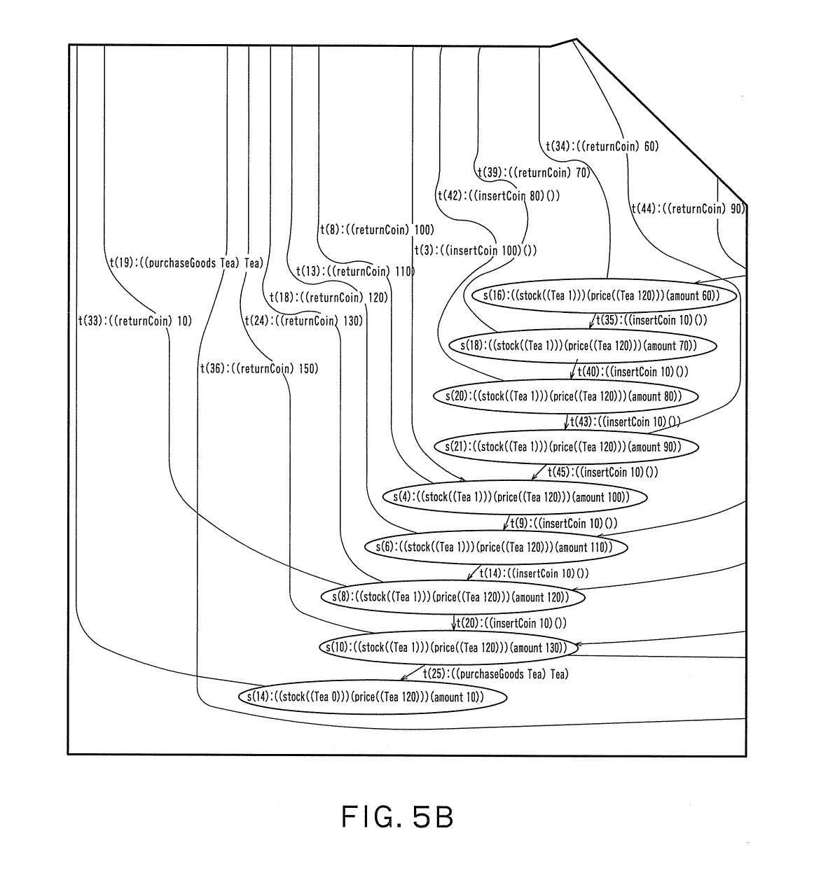

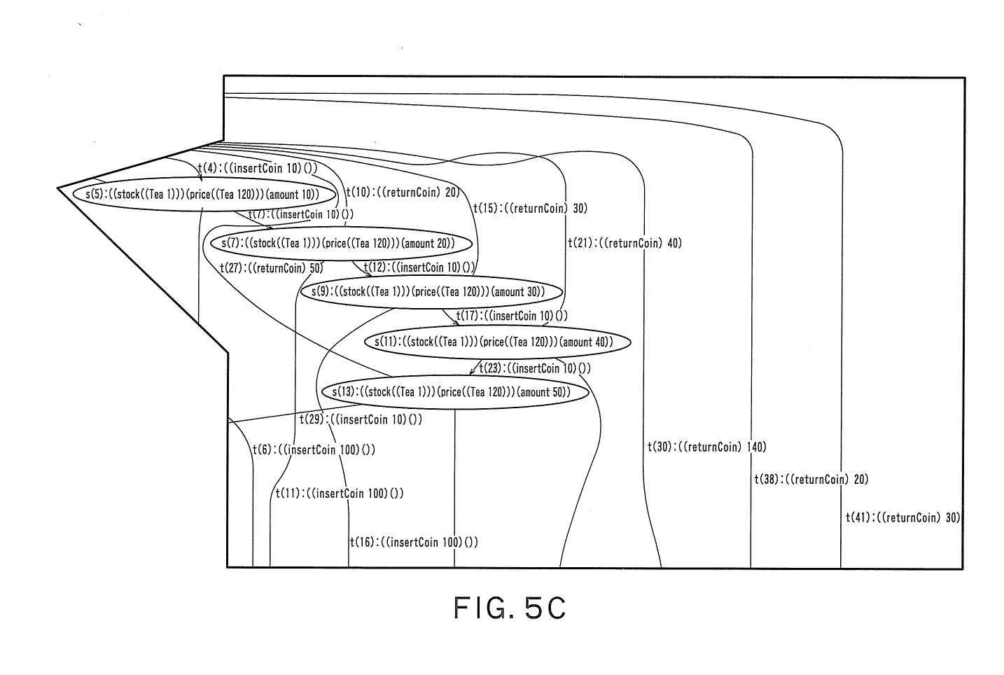

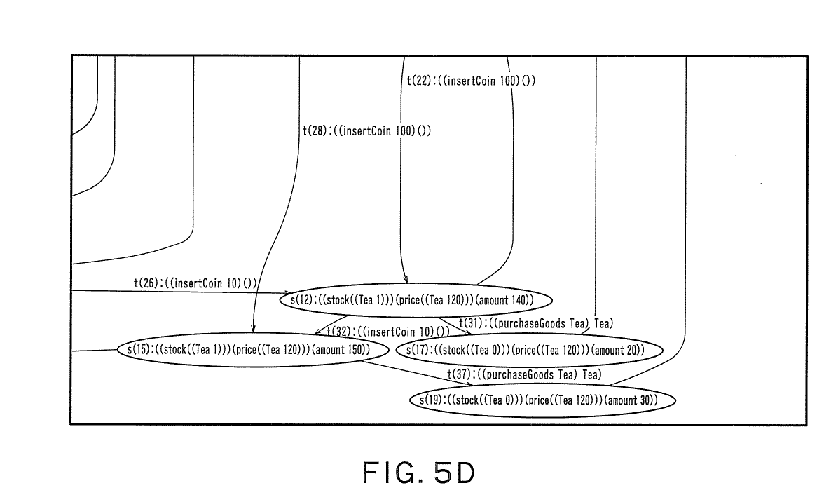

The states of the system and the transitions therebetween generated in the above steps (that is, the state transition diagram in the table of FIG. 4) can be expressed as a graph structure shown in FIG. 5. This graph structure has 22 states (nodes) and 44 transitions (arcs). The arrowed line (arc) starting from each state corresponds to the event which can be executed at the state (transition event).

The series of transitions which can be executed in the system state transition diagram of FIG. 5 corresponds to the state changes which can be carried out in the system. For example, when events are sequentially executed in the order of rg, sp, ss, and c10 from the initial state s0, the system state changes in the order of S1, s2, s3, and s5. Whether an actual vending machine satisfies the operation specification can be checked by generating the events in the actual the vending machine and confirming same operations as those shown in the operation specification. The test case is a transition series (transition path) made up of the transitions which should be checked. In the above example, the series of “rg, sp, ss, and c10” corresponds to the test case. Hereinafter, the transition path generator 17 generates the test case (transition path) based on the system state transition diagram 16 created considering the restrictions of the scenario state transition diagram 15. However, the above explanation is made based on the system state transition diagram of FIG. 5 created without considering the scenario state transition diagram 15 for easy understanding.

An efficient test case is a transition series covering every transition in the system state transition diagram and made as short as possible. When considering a directed graph in which the state of the state transition diagram is represented by a vertex and the transition is represented by an arc, an efficient test case corresponds to the minimum transition series covering every transition. A test case formed of such a minimum transition series can be obtained by calculating a traversable transition path (i.e. a transition path traced without lifting a brush from a paper) which starts from the initial state to carry out every transition. How to generate such a minimum transition series is widely known as Chinese Postman Problem (CPP) in the field of graph algorithm. Based on this method, a transition series having a length of 104 (transition series obtained by arranging 104 transition events) can be obtained with respect to the state transition diagram of FIG. 5, for example. By using this transition series (test case), every transition can be covered although some transitions overlap each other. In this way, a systematic test case covering every transition can be generated.

The above test case generated without considering the scenario state transition diagram 15 (test case generated by a conventional method) can cover every transition among the system states. However, there is a problem that the operability of the test is ruined when the operation specification is complicated and the kinds of events are increased. That is, there is a problem that it is difficult to carry out the test when the scale of the test case becomes exponentially larger due to the increase in the kinds of events, which makes the state space exponentially larger. Generally, the operation specification is simplified or the kinds of events are restricted to restrain the scale of the test case enough to carry out the test.

However, there is a case where a desired test case cannot be generated when the operation specification is simplified and the kinds of events are restricted. For example, when the remaining amount of each kind of coin is not managed in order to simplify the operation specification, it is not possible to realize a model operation as when a stocked item cannot be sold due to the lack of change. Further, when only the item Tea is treated in order to restrict the kinds of events, it is not possible to realize a model operation as when the item Tea is out of stock but an item Coffee can be sold. Required is a method capable of treating a complicated operation specification and various events reflecting the actual system while restraining the increase in the scale of the state transition diagram.

In the present embodiment, such a method is realized by restricting the transition events which can be executed in the operation specification by using the “scenario state transition diagram (event restricted DFA)” when creating the system state transition diagram. Hereinafter, this process will be explained in detail.

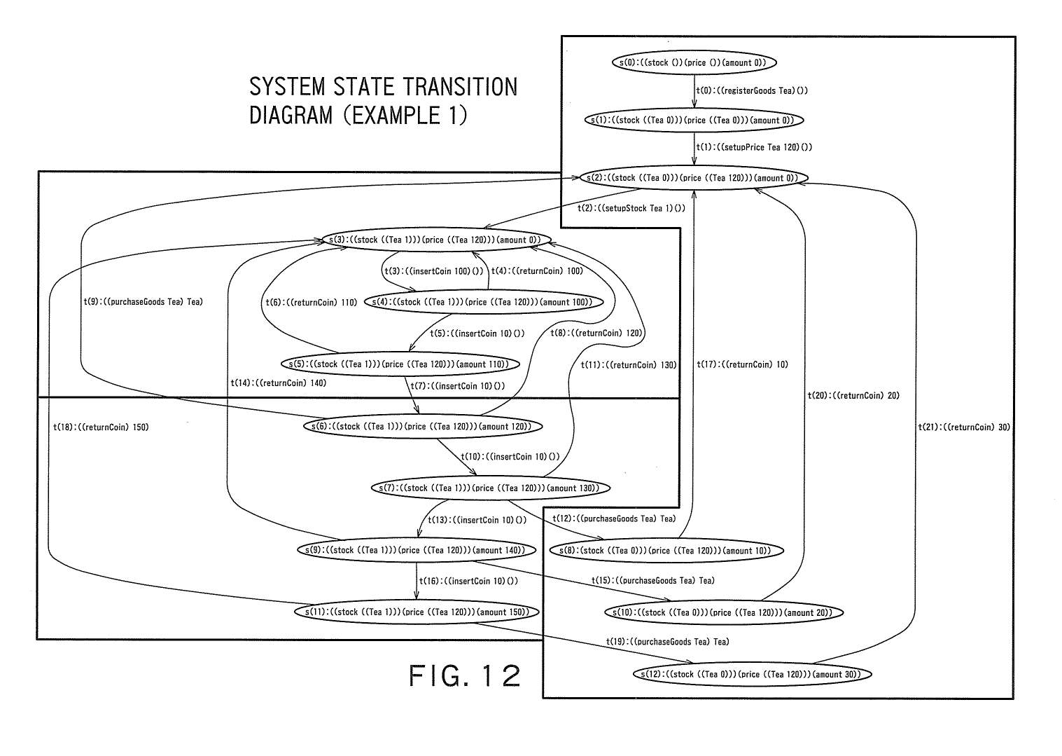

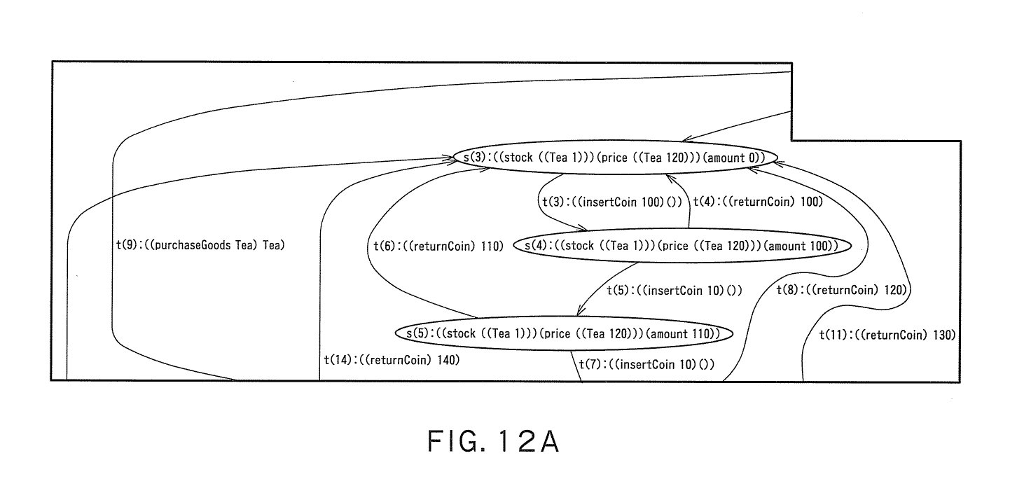

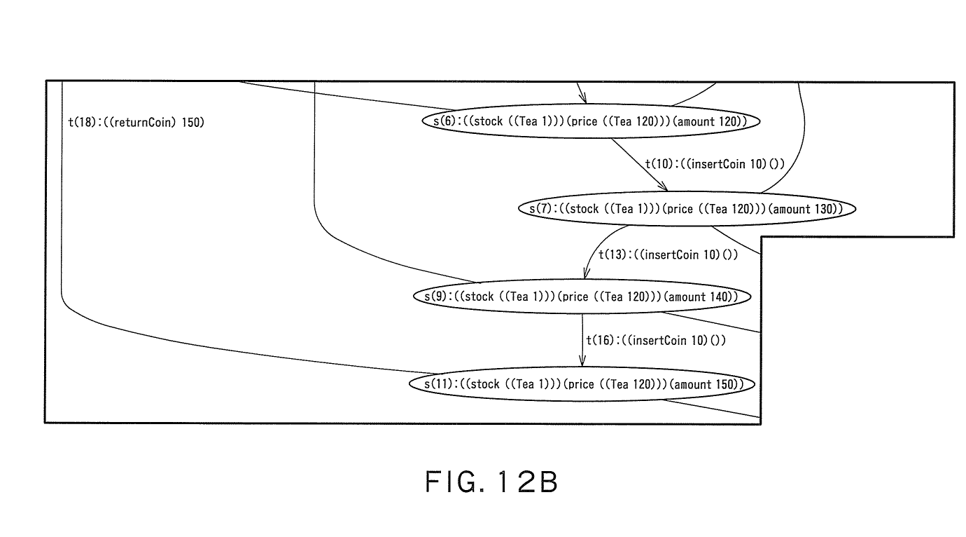

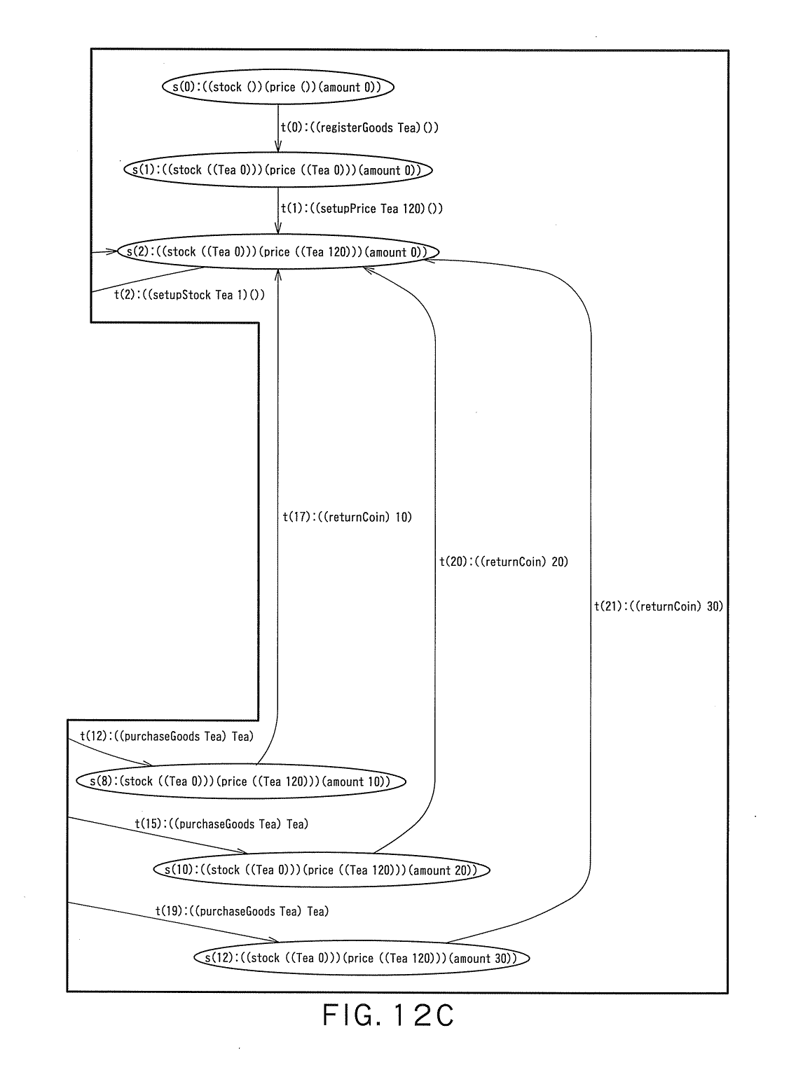

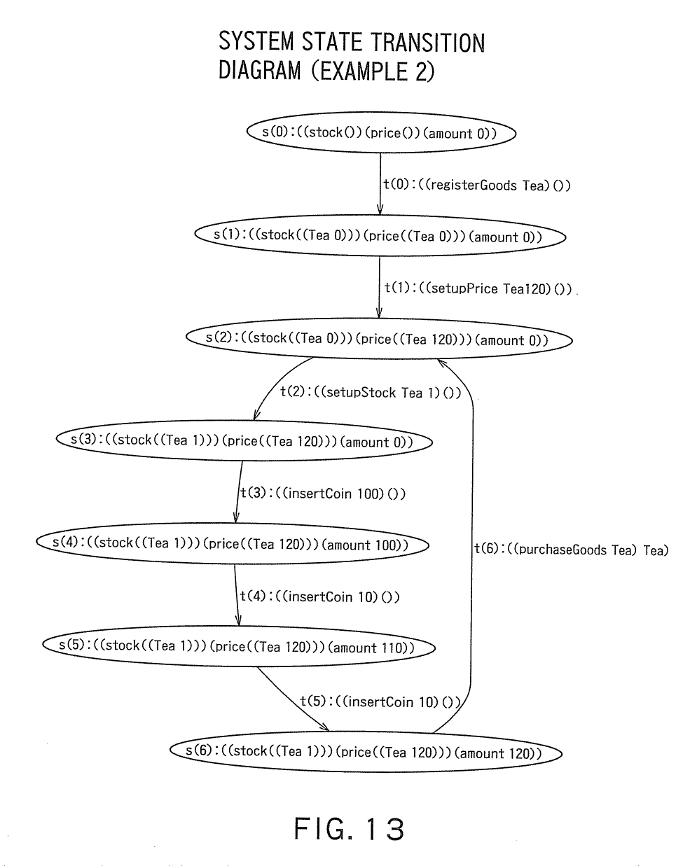

The scale of the system state transition diagram can be restrained when restricting the order in which the transition events are searched in the system state space (see FIG. 3). For example, in the system state transition diagram of FIG. 5, multiple states and the transitions therebetween are included according to the remaining “amount” of inserted coins. However, the order in which coins are inserted can be restricted if various states of the remaining amount do not need to be taken into consideration when performing the test. For example, the order in which coins are inserted can be restricted by determining that coins should be inserted in the order from the largest amount, by which the number of states can be restricted and the scale of the system state transition diagram can be restricted as shown in FIG. 12 or FIG. 13, which will be explained later.

In the present embodiment, in order to restrict the order in which the transition events are executed, the transition events which can be executed next in the system state space are restricted by the present state of the “scenario state transition diagram”, which includes finite internal states each of which is transited by a transition event.

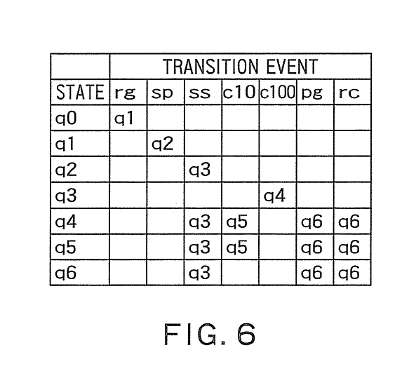

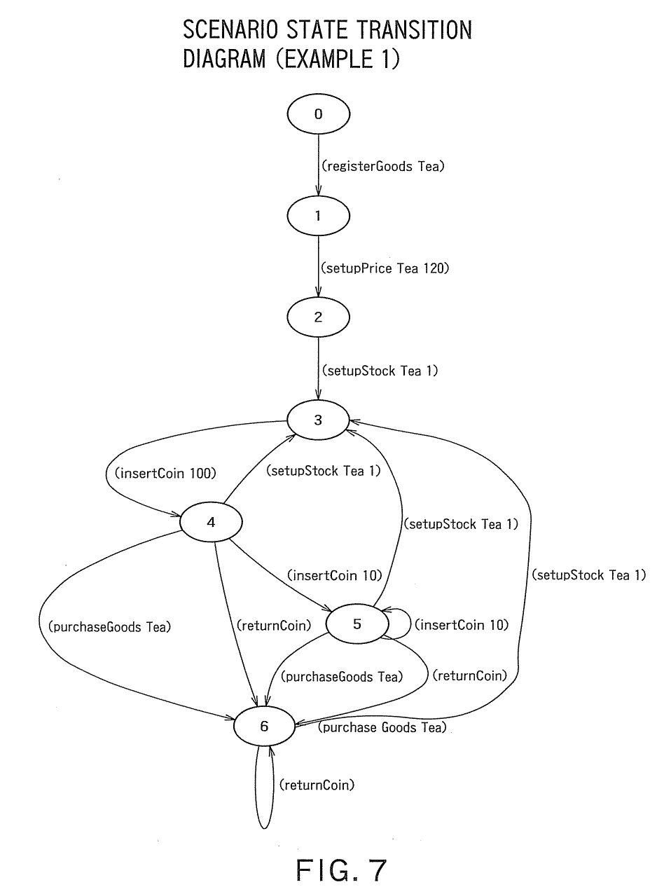

The table of FIG. 6 shows an example (example 1) of a scenario state transition diagram which has finite internal states (second states) in which the transitions are decisive (that is, the scenario state transition diagram has finite internal states and the next state is determined every time one symbol is read). The table of FIG. 6 can be expressed as a graph structure shown in FIG. 7.

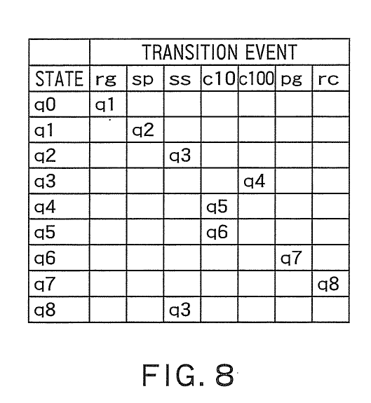

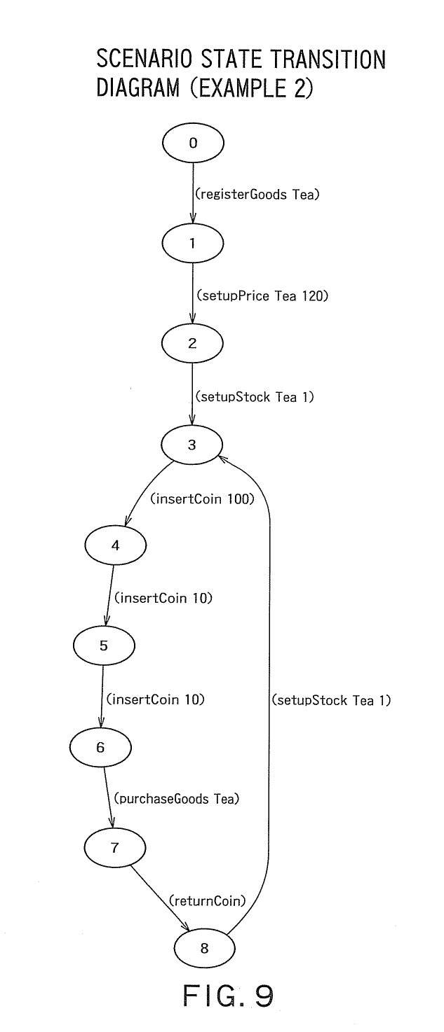

The table of FIG. 8 shows another example (example 2) of the scenario state transition diagram. The table of FIG. 8 can be expressed as a graph structure shown in FIG. 9.

In the table of FIG. 6 or the table of FIG. 8, rows correspond to the internal states (second states) q0, q1, q3 . . . q6 respectively, while columns correspond to the transition events rg, sp, ss, c10, c100, pg, and rc respectively. The internal state (second state) corresponds to the value of the second variable. The cell at which the row and the column intersect describes a transited internal state when a transition event corresponding to the internal state (second state) is executed. Each blank cell shows that the transition event is restrained from being executed by the corresponding internal state.

For example, in the table of FIG. 6, only the transition event rg can be executed when the present state is q0, and the state transits to the state q1 when the transition event rg is executed at the state q0. At the state q0, the other transition events sp, ss, c10, c100, pg, and rc are restrained from being executed. Further, the transition events ss, pg, and rc can be executed when the state is q6, and the state transits to q3 when the transition event ss is executed, transits to q6 when the transition event pg is executed, and transits to q6 when the transition event rc is executed. At the state q0, the transition event rg is a decisive transition since it is the only transition event which can be executed. A decisive transition corresponds to the row including one state or no state.

Such a scenario state transition diagram is created by the scenario state transition diagram creator 13 based on the scenario information 12 including a scenario description (transition event order description) describing a scenario pattern in a regular language and the above correspondence table (correspondence information).

Here, the scenario pattern is a pattern of the transition series permitted by the scenario state transition diagram. The regular language is used to describe a pattern by combining finite kinds of symbols with three kinds of special symbols (“.” representing sequence, “|” representing selection, and “*” representing repetition). A formula obtained by combining the finite kinds of symbols with the special symbols (“.” representing sequence, “|” representing selection, and “*” representing repetition) is called a regular expression, and the regular language can be said to be the whole symbol string satisfying the regular expression.

When the scenario pattern is expressed in the regular language, the scenario state transition diagram in the table of FIG. 6 (or FIG. 7) corresponds to the scenario pattern of “(rg. sp. (ss. c100. (c10)*. (pg|rc)*)*)”. The correspondence between the table of FIG. 6 or FIG. 7 and the scenario of “(rg. sp. (ss. c100. (c10)*. (pg|rc)*)*)” expressed in the regular language is as follows. Referring to the transition series starting from the initial state 0 in FIG. 7, the state 0 to the state 4 are restricted to the transitions rg, sp, ss, and c100 respectively, but at the state 4, any one of the transitions ss, c10, rc, and pg leading to the states 3, 5, 6, and 6 respectively can be generated. For example, when the state 4 is shifted to the state 5 by the transition c10, the transition c10 can be executed again and again at the state 5, but the transition c10 cannot be executed any more when the state 5 is shifted to the state 6 by the transition pg or rc. As stated above, the transition series starting from the initial state 0 in FIG. 6 and FIG. 7 can express a scenario in the regular language.

Further, the scenario state transition diagram in the table of FIG. 8 (or FIG. 9) corresponds to the scenario pattern of “(rg. sp. (ss. c100. c10. pg. rc)*)”.

With respect to the order in which coins are inserted, the table of FIG. 6 (or FIG. 7) shows that a 10 yen coin can be inserted at arbitrary times after a 100 yen coin is inserted once, while the table of FIG. 8 (or FIG. 9) shows that a 10 yen coin can be inserted only twice after a 100 yen coin is inserted once. Note that the pattern of the transition series permitted in the system state transition diagram of FIG. 4 or FIG. 5 can be expressed as (rg.sp.(ss|c100|c10|pg|rc)*)) in the regular language.

The scenario information 12 including the scenario pattern description (transition event order description) described in the regular language and the above correspondence table (showing the correspondence among the state before transition, a transition event, and the state after the transition) is input into the scenario state transition diagram creator 14. The scenario state transition diagram creator 14 creates the scenario state transition diagram 15 from this scenario information 12. For example, the scenario state transition diagram 15 can be created by sequentially generating transitions starting from the initial state q0 to cover every transition pattern in the scenario, generating a node representing a new state in accordance with generation of each of the transitions, and by adding an arc corresponding to the transition. It is also possible to create the scenario state transition diagram 15 by using the method of the above Document 1.

As stated above, when the scenario state transition diagram 15 is created, the system state transition diagram creator 13 refers to the operation specification 11 to create the simplified system state transition diagram 16 based on the restrictions of the scenario state transition diagram 15. Accordingly, a simplified system state transition diagram can be created from the original operation specification by restricting the operation within the range of the scenario pattern described in the regular language. Accordingly, in the present embodiment, it is possible to create a system state transition diagram restraining the number of states in accordance with a test purpose without simplifying the operation specification or restricting the kinds of events. After such a simplified system state transition diagram is created, a test case is generated by the above test case generating method and the actual test can be carried out.

The system state transition diagram creator 13 of FIG. 1 creates the simplified system state transition diagram 16 by searching through the system state space described in the operation specification 11 while considering the event restrictions shown by the scenario state transition diagram 15 created by the scenario state transition diagram creator 14. Hereinafter, in order to provide an easy understanding, the operation of the system state transition diagram creator 13 will be explained based on a concrete example first, and after that, the operation algorithm of this device will be explained in detailed referring to FIG. 2.

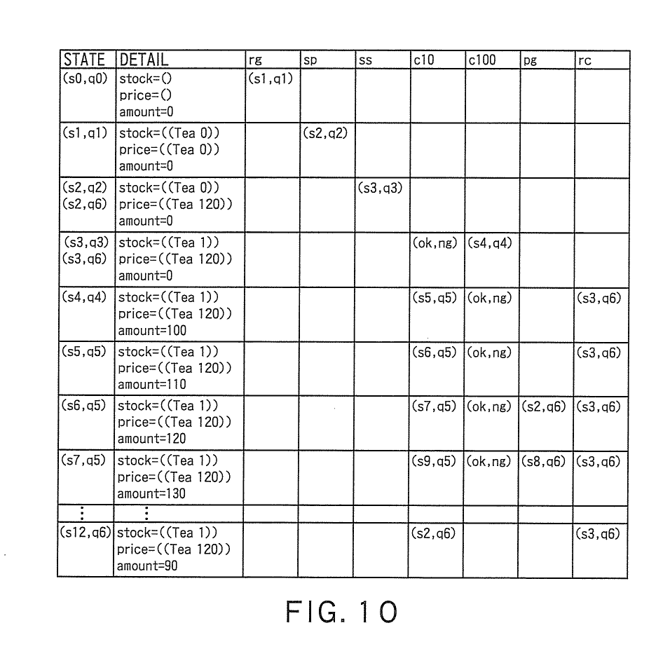

FIG. 10 shows how to search through the state space described in the operation specification of FIG. 3 while considering the restrictions of the scenario state transition diagram in the table of FIG. 6. This search is performed based on a composite state (s, q), which is a set of a state s in the system state transition diagram and a state q in the scenario state transition diagram. Hereinafter, search steps will be shown in detail.

A composite state (s0, q0), which is a set of the initial state of the system state transition diagram and that in the scenario state transition diagram, is registered in the first row of a table as shown in FIG. 10. The transition events rg, sp, ss, c10, c100, pg, and rc are previously registered in respective columns in the table of FIG. 10. Here, the initial state s0 in the system is generated immediately after the initialization process VendingMachine( ) is performed. That is, the state s0 is a state in which no item is registered (stock=( ), the price of the item is not registered (price=( ), and the amount of inserted coins is 0 (amount=0).

Every transition event which can be executed in this initial composite state (s0, q0) is listed. Concretely, every event which satisfies the pre-condition of the system described in the operation specification and which can transit in the scenario state transition diagram is listed. The transition event which can transit both in the initial states (s0, q0) of the system state transition diagram and the scenario state transition diagram can be executed (generated) in the composite state (s0, q0).

Transition events satisfying this condition in the composite state (s0, q0) are searched based on the table of FIG. 6 and the table of FIG. 3 to find that only the transition event rg can be executed. That is, the table of FIG. 3 shows that only the event rg for registering the item can be executed at the state s0 (stock=( ), price=( ), amount=0), while the table of FIG. 6 shows that only the event rg can be executed at the state q0 since there is no other events corresponding to the state q0. Accordingly, only the event rg is listed.

When a transition event which can be executed is listed, the state of the system state transition diagram (first state) and the state of the scenario state transition diagram (second state) are transited respectively in accordance with the listed transition event. When the composite state (s0, q0) is transited in accordance with the transition event rg, a transited composite state (s1, q1) is generated. That is, the registration of the item g at the state s0 generates a new state (labeled s1), in which the values of the price and stock of the item g are both 0 (stock=((Tea 0)), price=((Tea 0))) and the amount of inserted coins is 0 (amount=0). Here, “Tea” is registered as the item g. Further, the table of FIG. 6 shows that the state q1 is described in the cell at which the row of the state q0 and the column of the event rg intersect. Accordingly, the transited composite state is (s1, q1). This composite state is entered in the cell at which the row of the composite state (s0, q0) and the column of the event rg intersect in the table of FIG. 10.

When a new composite state is generated as a result of the transition, it is added to a new row as in the above normal state search. Since the state (s1, q1) is a new composite state, the state (s1, q1) is added to the second row in the table of FIG. 10.

A transition event which can be transited from this new composite state (s1, q1) is listed to transit the state of the system state transition diagram and the state of the scenario state transition diagram. The table of FIG. 3 shows that only the event sp for registering the price of the item can be executed at the state s1, while the table of FIG. 6 shows that only the event sp can be executed at the state q1. Since there is an AND logic between these events, only the transition event sp can be executed in the composite state (s1, q1). Accordingly, the composite state (s1, q1) is transited by the transition event sp and a transited composite state (s2, q2) is generated. That is, the complex-state transition of ((s1, q1), sp, (s2, q2)) is obtained. Note that the state s2 can be expressed as (stock=((Tea 0)), price=((Tea 120)), (amount=0)).

The composite state (s2, q2), which is newly obtained, is added to the third row in the table of FIG. 10. Hereinafter, a similar process is repeated until no more new composite state is generated.

In the table of FIG. 10, composite states including the same system state are described in the same row. For example, the composite states (s2, q2) and (s2, q6), which include the system state s2 in common, are described in the same row.

Further, the composite state (ok, ng) in the table of FIG. 10 shows that transition is unsuccessfully performed since the transition is permitted by the system state transition diagram but is restricted by the scenario state transition diagram. For example, referring to the composite state (ok, ng) in the cell at which the fourth row and the fourth column intersect, insertion of a 10 yen coin is restricted at the state s3 since the transition event c10 for inserting a 10 yen coin is permitted at the state s3 corresponding to the fourth row but is not permitted at the state q3 or q6.

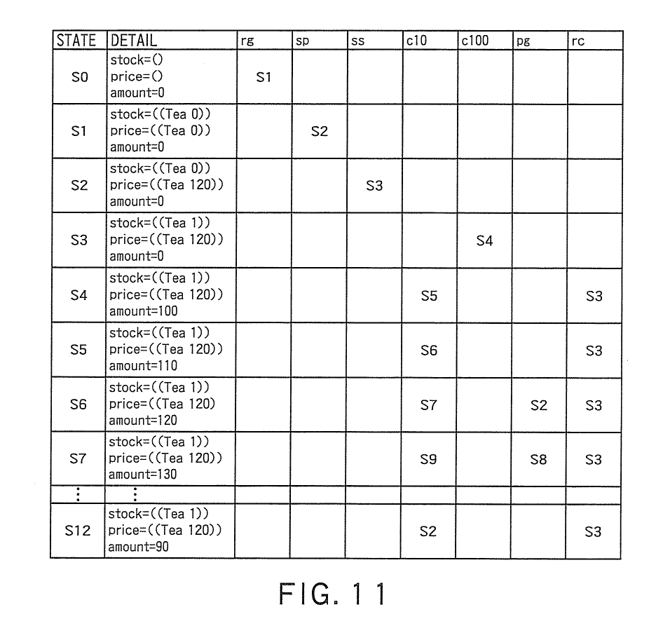

The above process is repeated until no more new composite state is generated, and the complex-state transition diagram (that is, the table of FIG. 10) obtained by the search is projected on the system state transition diagram. That is, the difference in the scenario state is ignored in the complex-state transition diagram to unify a plurality of composite states having the same system state into one system state. Concretely, referring to the third second row in the table of FIG. 10, the projection is performed so that the composite states (s2, q2) and (s2, q6) are unified into the state s2 while the composite state (s3, q3) becomes the state s3, for example. The table of FIG. 11 can be obtained by projecting the table of FIG. 10 on the system. Note that the composite state (ok, ng) is removed when performing the projection. The table of FIG. 11 corresponds to a simplified system state transition diagram.

FIG. 2 is a flow chart showing the algorithm of the operation performed by the system state transition diagram creator 13.

First, a list X, a list S, and a list T are initialized (S11). Due to the initialization, the initial composite state (s0, q0) is stored in each of the list X and the list S, and the list T becomes blank. The list S stores a composite state found by the state search in this flow, and the initial composite state (s0, q0) stored in the list S is regarded as being found by the search. The list X stores a candidate composite state for the search, and the initial composite state (s0, q0) is stored in the list X as the search candidate in this case. The list T stores a complex-state transition ((s, q), e, (s′, q′)) found by the state search, and the list T is blank at this point since no complex-state transition is found. Note that “e” represents a transition event.

Here, the state s0 corresponds to a initial first state representing the initial values of a plurality of the state variables in the system. The state q0 corresponds to a initial second state, which is the initial state of the scenario state transition diagram. The list T corresponds to a first list (or a first temporary storage) of the present invention, for example, and the list X corresponds to a second list (or a second temporary storage) of the present invention, for example. Each of the first list and the second list may be an internal buffer of an arithmetic device, or may be a storage area in a memory device such as a DRAM and an SRAM.

In step S12, whether the list X is blank is checked. Since the list X is not blank in this case, one element (composite state) is taken out from the list X as a composite state x. Here, the composite state (s0, q0) is taken out as the composite state x.

Every event e of a set E (rg, sp, ss, c10, c100, pg, and rc) is examined as to whether it can be executed at the composite state selected in step S13, and a process corresponding to the examination result is performed (EXPAND(x, e)) (S14). Concretely, the process from step S21 to S25 is performed on each event e.

First, whether or not the event e can be executed at the composite state x is judged based on the operation specification 11 and the scenario state transition diagram 15 (S21). That is, it is judged whether or not the event e can be executed at the state s (the initial first state or the first state) in the composite state x and at the state q (the initial second state or the second state) in the composite state. When the event e can be executed both at the state s and the state q, the event e is a common transition event which can be executed at the state s and the state q. As stated above, in step S21, a common transition event which can be executed at both states is detected.

When the event e cannot be executed at the composite state x, the process is ended (NO branch in S21). When the event e can be executed (YES branch in S21), the composite state x is transited by the event e to obtain a transited composite state x′ (S22). That is, the state s (the initial first state or the first state) and the state q (the initial second state or the second state) are transited by the event e to obtain a transited state s′ and a transited state q′ (that is, a transited first state and a transited second state) respectively. A pair (s′, q′) formed of the transited the state s′ and the transited state q′ corresponds to the composite state x′.

Whether the composite state x′ is obtained for the first time is judged (S23). When it is the first time (YES), the composite state x′ is stored in the list X (S24).

After the composite state x′ is stored in the list X or when it is judged that the composite state x′ is not found for the first time (NO branch in S23), the composite state x′ is added to the list S (not necessary if the same composite state is previously added to the list S) and a complex-state transition (x, e, x′) is added to the list T (S25).

After the process from step S21 to S25 is performed on each event e, the flow returns to step S12 to judge whether the list X is blank. When the list X is not blank (NO), the flow proceeds to step S13 to repeat the above process.

When the list X is blank (YES branch in step S12), the flow proceeds to step S15 to project each element (composite state) in the list S and the composite state included in each element (complex-state transition) in the list T, to the system state (S15). For example, the composite state (s0, q0) in the list S is projected to s0, the composite states (s2, q2) and (s2, q6) are unified to be projected to s2, and the complex-state transition ((s0, q0), rg, (s1, q1)) is projected to (s0, rg, S1) (see FIG. 10 and FIG. 11). In this manner, the list S and the list T are projected is output. The projected list T corresponds to state transitions in the system state transition diagram 16 and the projected List S corresponds to states in the system state transition diagram 16, for example.

In step S12 of the above flow, the element (composite state) is taken out (extracted) from the list X. Alternatively, it is also possible to select an unselected element from the list X. In this case, it is also possible to repeat the process of marking each element selected from the list X until all of the elements are selected from the list X. When all of the elements are selected, the flow proceeds to step S15. Accordingly, taking out an element from the list X is merely an example of selecting an element.

Further, in the above flow, the complex-state transition (x, e, x′) is added to the list T in step S25 and the projection on the system state is performed in step S15. However, the projection can be performed when storing the complex-state transition in the list T. That is, (s, e, s′) obtained by projecting the complex-state transition (x, e, x′) to the system state can be stored in the list T in step S25. That is, a set of the previous state s, the transition event e, and the transited state s′ can be stored in the list T in step S25. This can be similarly applied to the list S. As stated above, the projection can be performed at the output timing in step S15 or at the storage timing for the list T or the list S in step S25.

Hereinafter, an example of a system state transition diagram created considering the restrictions of the scenario state transition diagram 15 will be shown.

FIG. 12 shows a simplified system state transition diagram (example 1) (corresponding to the table of FIG. 11) created considering the restrictions of the scenario state transition diagram (event restricted DFA) of FIG. 6. There are 13 states and 22 transitions.

FIG. 13 shows a simplified system state transition diagram (example 2) created considering the restrictions of the scenario state transition diagram (event restricted DFA) of FIG. 8. There are 7 states and 7 transitions.

On the other hand, FIG. 5, which is explained above, shows a system state transition diagram (based on the conventional method) created without considering the scenario state transition diagram from the operation specification of FIG. 3. There are 22 states and 44 transitions.

As stated above, when a simplified system state transition diagram is created, the transition path generator 17 can generate a test case from this system state transition diagram. Hereinafter, an example of the generated test case will be shown.

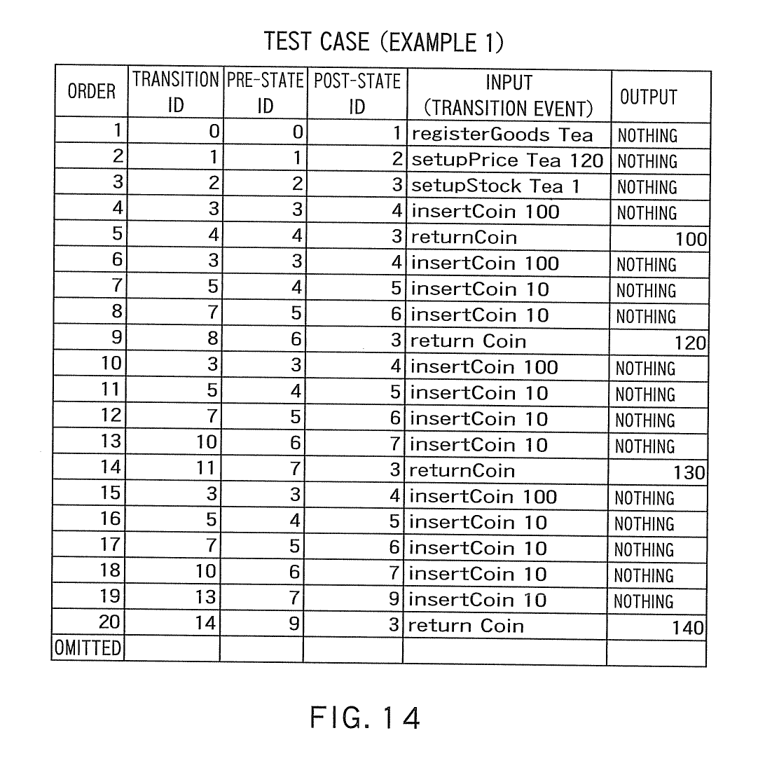

The table of FIG. 14 shows an example of the test case generated from the system state transition diagram of FIG. 12. This example is partially shown and the test length (the length of the transition series) is 35. That is, the above 22 transitions can be covered by successively transiting the state 35 times. Note that the test case (transition path) should be always started from the initial state s0 (the same can be applied to the following).

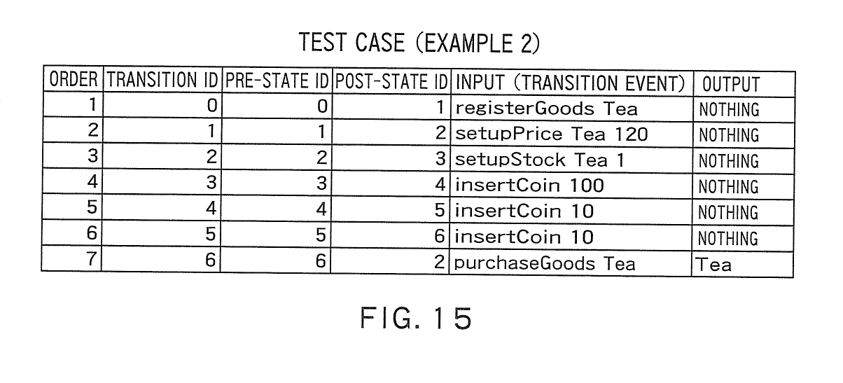

The table of FIG. 15 shows an example of the test case generated from the system state transition diagram of FIG. 13. The test length (the length of the transition series) is 7. That is, the above 7 transitions are covered by successively transiting the state 7 times.

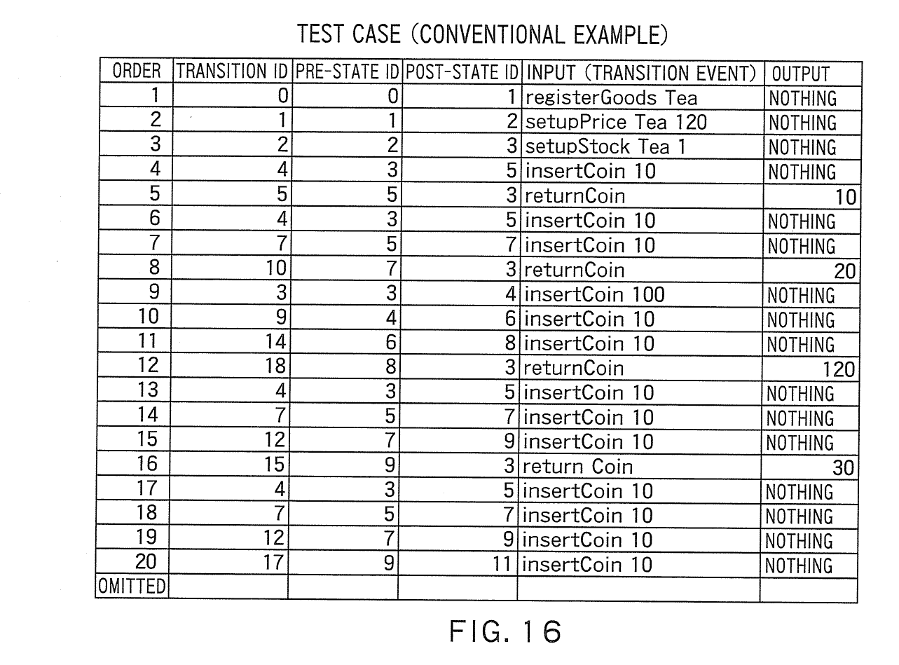

On the other hand, FIG. 16 shows an example of the test case generated from the system state transition diagram (based on the conventional method) without considering the restrictions of the scenario state transition diagram. This example is partially shown and the test length (the length of the transition series) is 104. That is, 44 transitions are covered by successively transiting the state 104 times.

The following table shows the comparison between the conventional method and the examples 1 and 2.

| | Conventional | | |
|---|---|---|---|
| | method | Example 1 | Example 2 |
| Scenario | Equivalent of | (rg.sp.(ss.c100. | (rg.sp.(ss.c100. |
| description | (rg.sp.(ss\|c100\| | (c10)*.(pg\|rc) | c10.pg.rc)*) |
| | c10\|pg\|rc)*)) | ′*)*) | |
| Scenario | Nothing | FIG. 6, FIG. 7 | FIG. 8, FIG. 9 |
| System | FIG. 5 | FIG. 12 | FIG. 13 |
| Test case | FIG. 16 | FIG. 14 | FIG. 15 |
| (Transition | | | |
| path) | | | |
| Number of | 22 | 13 | 7 |
| states | | | |
| Number of | 44 | 22 | 7 |
| transitions | | | |
| Test | 104 | 35 | 7 |
| length | | | |

As understood from this comparison table, the scale of the system state transition diagram is controlled by effectively selecting the scenario (description of the event restrictions) so that the scale of the test case generated from the system state transition diagram can be controlled.

As stated above, according to the present embodiment, since the scenario state transition diagram restricting the order in which the transition events are executed is employed and the system state transition diagram is created based on this scenario state transition diagram from the operation specification, it is possible to treat a complicated operation specification and various events reflecting the actual system while restraining the scale of the system state transition diagram and the scale of the test case.

An example of a system operation specification (for a vending machine described in the Java language)

import fsm2.*;
import fsm2.util.*;
import java.util.*;
// Vending Machine
public class VendingMachine extends _SPEC_ {

// State
MAP<String,Integer> stock;
MAP<String,Integer> price;
Integer amount;
//
public VendingMachine( ) {

stock = new MAP<String,Integer>( );
price = new MAP<String,Integer>( );
amount = 0;

}
//
public void registerGoods(String g) throws Exception {

require(stock.get(g) == null);
require(price.get(g) == null);
stock.put(g, 0);
price.put(g, 0);

}
//
public void setupPrice(String g, Integer p) throws

Exception {

require(price.get(g) != null);
require(amount == 0); // must not change price while

buying.

Integer r = price.get(g);
require(!r.equals(p));
price.put(g, p);

}
//
public void setupStock(String g, Integer n) throws

Exception {

require(stock.get(g) != null);
require(price.get(g) != 0); // must not stat selling in

free.

require(amount == 0); // must not change stock while

buying.

Integer m = stock.get(g);
stock.put(g, m + n);

}
//
public void insertCoin(Integer c) throws Exception {

require(existStock( )); // must not insert coin under no

stock.

amount = amount + c;

}
//
private boolean existStock( ) {

Set<String> keys = stock.keySet( );
for (Iterator<String> iter = keys.iterator( );

iter.hasNext( ); ) {

String g = iter.next( );
if (existStock(g)) return true;

}
return false;

}
//
private boolean existStock(String g) {

Integer n = stock.get(g);
return (n != null) && (n > 0);

}
//
private boolean enoughMoney(String g) {

Integer p = price.get(g);
return (p != null) && (amount >= p);

}
//
private boolean availablePurchase(String g) {

return existStock(g) && enoughMoney(g);

}
//
public String purchaseGoods(String g) throws Exception {

require(availablePurchase(g));

Integer n = stock.get(g);
Integer p = price.get(g);
stock.put(g, n − 1);
amount = amount − p;
return g;

}
//
public Integer returnCoin( ) throws Exception {

require(amount > 0);
Integer ret = amount;
amount = 0;

return ret;

}

}

What is claimed is:

1. A test case generating device including a computer readable storage medium containing a set of instructions that causes a computer processor to perform generating a test case for a target system, comprising:
a first storage configured to store a system operation specification describing: a plurality of first variables representing a first state by a combination of values of the first variables; a plurality of transition events; a plurality of pre-conditions each to be satisfied by the first variables in order to execute each of the transition events; and a formula for updating values of the first variables when each of the transition events is executed;
a second storage configured to store a scenario state transition diagram describing transitions among a plurality of second states in accordance with execution of the transition events;
a first creator configured to create a system state transition diagram describing transitions among first states in accordance with the execution of the transition events based on the system operation specification and the scenario state transition diagram;
a test case generator configured to generate a test case which is a series of transition events covering all transitions in the system state transition diagram by sequentially tracing each transition in the system state transition diagram; and
a test case output unit configured to output the test case,
wherein
the first creator
has a first list and a second list for temporarily storing data;
generates an initial first state by determining initial values of the first variables;
specifies an initial second state of the second states in the scenario state transition diagram;
detects a common transition event which can be executed both at the initial first state and the initial second state from among the transition events the pre-conditions and the scenario state transition diagram;
transits the initial first state and the initial second state by the common transition event to obtain a transited first state and a transited second state, and stores, in the first list, a set of items of the initial first state, the common transition event and the transited first state;
stores a composite state which is a pair of the transited first state and the transited second state, in the second list;
(A) selects the composite state which is not previously selected, in the second list;
(B) detects a common transition event which can be executed both at the first state and the second state included in a selected composite state from among the transition events, transits the first state and the second state by the common transition event to obtain a transited first state and a transited second state, and stores a set of items of the first state in the selected composite state, the common transition event and the transited first state, in the first list;
(C) stores a composite state which is a pair of the transited first state and the transited second state obtained in the step (B), in the second list when the composite state does not exist in the second list; and
repeats the steps (A) to (C) until all of composite states existing in the second list are selected at the step (A) and then obtains all of sets existing in the first list as representing the system state transition diagram.

2. The device according to claim 1 further comprising:
a third storage configured to store
a scenario description describing a constraint on an order of execution of the transition events and
correspondence information among the second state, the transition event being able to be executed at the second state and the transited second state as when the transition event is executed at the second state; and
a second creator configured to create the scenario state transition diagram by sequentially generating the transition events starting from the initial second state in accordance with the scenario description based on the correspondence information.

3. A computer-implemented method of generating a test case for a target system, comprising:
reading out a system operation specification from a first storage, the system operation specification describing: a plurality of first variables representing a first state by a combination of values thereof; a plurality of transition events; a plurality of pre-conditions each to be satisfied by the first variables in order to execute each of the transition events; and a formula for updating values of the first variables when each of the transition events is executed;
reading out from a second storage, a scenario state transition diagram describing transitions among a plurality of second states in accordance with execution of the transition events;
creating a system state transition diagram describing transitions among first states in accordance with the execution of the transition events based on the system operation specification and the scenario state transition diagram;
generating a test case which is a series of transition events covering all transitions in the system state transition diagram by sequentially tracing each transition in the system state transition diagram; and
outputting the test case,
wherein
the creating the system state transition diagram including:
generating an initial first state by determining initial values of the first variables;
specifying an initial second state of the second states in the scenario state transition diagram;
detecting a common transition event which can be executed both at the initial first state and the initial second state from among the transition events the pre-conditions and the scenario state transition diagram;
transiting the initial first state and the initial second state by the common transition event to obtain a transited first state and a transited second state, and storing, in a first list, a set of items of the initial first state, the common transition event and the transited first state;
storing a composite state which is a pair of the transited first state and the transited second state, in a second list;
(A) selecting the composite state which is not previously selected, in the second list;
(B) detecting a common transition event which can be executed both at the first state and the second state included in a selected composite state from among the transition events, transiting the first state and the second state by the common transition event to obtain a transited first state and a transited second state, and storing a set of items of the first state in the selected composite state, the common transition event and the transited first state, in the first list;
(C) storing a composite state which is a pair of the transited first state and the transited second state obtained in the step (B), in the second list when the composite state does not exist in the second list; and
repeating the steps (A) to (C) until all of composite states existing in the second list are selected at the step (A) and then obtaining all of sets existing in the first list as representing the system state transition diagram.

4. A computer-readable recording medium storing a computer program for causing a computer to execute instructions to perform steps of:
reading out a system operation specification from a first storage, the system operation specification describing: a plurality of first variables representing a first state by a combination of values thereof; a plurality of transition events; a plurality of pre-conditions each to be satisfied by the first variables in order to execute each of the transition events; and a formula for updating values of the first variables when each of the transition events is executed;
reading out from a second storage, a scenario state transition diagram describing transitions among a plurality of second states in accordance with execution of the transition events;
creating a system state transition diagram describing transitions among first states in accordance with the execution of the transition events based on the system operation specification and the scenario state transition diagram;
generating a test case which is a series of transition events covering all transitions in the system state transition diagram by sequentially tracing each transition in the system state transition diagram; and
outputting the test case,
wherein
the creating the system state transition diagram including:
generating an initial first state by determining initial values of the first variables;
specifying an initial second state of the second states in the scenario state transition diagram;
detecting a common transition event which can be executed both at the initial first state and the initial second state from among the transition events the pre-conditions and the scenario state transition diagram;
transiting the initial first state and the initial second state by the common transition event to obtain a transited first state and a transited second state, and storing, in a first list, a set of items of the initial first state, the common transition event and the transited first state;
storing a composite state which is a pair of the transited first state and the transited second state, in a second list;
(A) selecting the composite state which is not previously selected, in the second list;
(B) detecting a common transition event which can be executed both at the first state and the second state included in a selected composite state from among the transition events, transiting the first state and the second state by the common transition event to obtain a transited first state and a transited second state, and storing a set of items of the first state in the selected composite state, the common transition event and the transited first state, in the first list;
(C) storing a composite state which is a pair of the transited first state and the transited second state obtained in the step (B), in the second list when the composite state does not exist in the second list; and
repeating the steps (A) to (C) until all of composite states existing in the second list are selected at the step (A) and then obtaining all of sets existing in the first list as representing the system state transition diagram.
